(19) United States
(12) Patent Application Publication
(10) Pub. No.: US 2020/0113662 A1
(43) Pub. Date: Apr. 16, 2020

(54) Method of Manufacturing A Dental Restoration Part

(71) Applicant: Ivoclar Vivadent AG, Schaan (LI)

(72) Inventors: Andreas Häfele Clemens, Weiler (AT); Sabrina Teichmann, Buchs (CH); Roger Frei, Heerbrugg (CH); Konrad Hagenbuch, Haag (CH)

(21) Appl. No.: 16/589,209

(22) Filed: Oct. 1, 2019

(30) Foreign Application Priority Data
Oct. 11, 2018 (EP) 18199941.8

(51) Int. Cl. A61C 13/08; A61C 13/01; A61C 13/00; B33Y 50/02; B33Y 80/00; B29C 64/393

(52) U.S. Cl. CPC A61C 13/082; A61C 13/01; A61C 13/0019; A61C 13/0013; B33Y 10/00; B33Y 50/02; B33Y 80/00; B29C 64/393; A61C 13/0004

(57) ABSTRACT

A method for manufacturing a dental restoration part according to patient-specific requirements is provided, which dental restoration part comprises a prosthesis base, wherein the prosthesis base carries at least one prefabricated artificial tooth, in particular a large number of prefabricated artificial teeth.

It is also intended for the prosthesis base to have a surface on the side facing away from the prefabricated artificial teeth, i.e. on the side opposite thereof, and a three-dimensional layer of material to be applied to this surface of the prosthesis base using a three-dimensional additive method, by which the prosthesis base will be fabricated according to the patient-specific specifications.

### CROSS-REFERENCE TO RELATED APPLICATIONS

This application claims priority to European patent application No. 18199941.8 filed on Oct. 11, 2018, the disclosure of which is incorporated herein by reference in its entirety.

### TECHNICAL FIELD

The present invention relates to a process for fabricating a dental restoration part, as well as a prefabricated dental restoration part, which is designed as a prosthesis having prefabricated artificial teeth, according to the invention.

### BACKGROUND

Dental prostheses comprising artificial teeth have been known for a long time. In addition to the quite laborious and time-consuming procedure for achieving a satisfactory occlusion result and providing an individually shaped prosthesis base comprising a large number of artificial teeth, procedures have been known employing prefabricated dental arches. This eliminates laborious insertion and alignment of individual artificial teeth.

However, to ensure exact fitting of the prosthesis base onto the patient's alveolar ridge, the prosthesis base must always be adapted to the patient's individual alveolar ridge, which is also a quite time-consuming process.

EP 2742907 along with U.S. Ser. No. 10/016,261, U.S. Ser. No. 10/182,893, U.S. Ser. No. 10/292,794, U.S. Pat. No. 9,295,534, US 20170265977, U.S. Ser. No. 10/357,344, U.S. Pat. No. 9,402,698, U.S. Ser. No. 10/231,806 and U.S. Ser. No. 10/251,733, which US patents and publications are all incorporated by reference herein, describe dental devices and computer-aided procedures used in the dental field. Artificial teeth are glued into apertures prepared in the prosthesis base, wherein the tooth necks of the artificial standard teeth partially extend through the prosthesis base. Following curing of the adhesive bonds, the back side of the prosthesis base will be ground using computer control, so that the resulting shape matches the negative shape of the patient's alveolar ridge, and the tooth necks protruding beyond the prosthesis base are simultaneously ground off in the same operation and thus will be shortened for exact fitting, the software being configured to consider a minimal remaining adhesive surface between the tooth and prosthesis base.

Despite simplification of the fabrication of a patient-specific prosthetic base using abrasive procedures, further simplification and promotion of the adjustment of the prosthetic base is still desired, while maintaining the optimum fit of the prosthetic base to ensure comfortable and pain-free wear experience.

### SUMMARY

Therefore, the object of the present invention is to provide a method according to the claims, as well as a prefabricated product according to the claims, allowing development of patient-specific adaptation or to shape a standard prosthesis base allowing said adaptation by making use of an additive method, as well as to provide a prefabricated product for the fabrication of a patient-specific dental restoration, i.e. a dental prosthesis.

According to the invention, this object will be solved by the method as well as the prefabricated product according to the claims. Advantageous embodiments will arise from the subclaims.

According to the invention, a parabolic or partially elliptical tooth material-prosthesis material body is applied in a layer-by-layer manner by a three-dimensional process, such as stereolithography to finally form the prosthesis base. This is done using computer control by CAD/CAM, where digital scan data of the patient's alveolar ridge have been recorded and processed in advance or processed to use in CAM production.

Alternatively, a subtractive process, such as a milling process, or the use of pressing technology is possible instead.

Instead of single teeth, arches or partial arches may also be used herein.

In another embodiment, it is intended to manufacture partial prostheses instead of full prostheses, wherein steps analogous to those mentioned above are carried out.

Prostheses for the upper and lower jaw may also be prefabricated such that they match onto each other without occlusal interfering contacts.

Herein, the teeth are aligned to each other in the occlusal, i.e. horizontal plane. The occlusal plane is thus automatically taken into account, and patient gingival information will also be considered or will be calculated at the same time. This provides for an esthetic final prosthesis with the remaining prosthesis base surface to be applied.

The base body of the prosthesis base, which may be connected to individual teeth or a large number of artificial teeth as well as entire dental arches, can be rigid or flexible, for example parabolic in the case of mandibular dentures or partially elliptical in the case of maxillary prostheses. It is also possible for the base body to be thermally deformable, i.e. shape adjustment is enabled by heating, which remains after cooling.

The artificial teeth are firmly connected to the base body of the prosthesis base. On the side of the denture base body opposite to the artificial teeth, there is a surface, which, in one embodiment, is formed as a flat surface. This surface may also be of any shape that differs from a flat surface. It is only essential for the artificial teeth or the dental arch inserted on the opposite side not to protrude beyond the surface to be coated using the three-dimensional additive method.

To increase surface area, the surface described above may be roughened or prepared by introducing grooves or any other suitable structure into the surface. This results in better adhesion of the layers, which are applied to the prosthesis base body by the three-dimensional additive method. In order to further improve adhesion of the layers to be applied, the surface may also be pre-treated with a primer or equivalent substances.

After completion of the above-described preparation of the surface, computer-aided manufacturing (CAM) of the patient-specific prosthesis base is carried out based on the data stored in the CAD device for the prosthesis base body and selected depending on the individual patient. Based on the 3D scan data of the patient, a suitable material is applied in a layer-by-layer manner using a three-dimensional additive method, such as stereolithography.

A dental restoration part can be produced from a prefabricated product having a prosthesis base. The prosthesis base carries prefabricated artificial teeth on one side and the prosthesis base has a blank surface on the side opposite the side with the prefabricated artificial teeth. The prefabricated product with teeth on one side and a blank surface on the side opposite the teeth is subsequently provided with additional layers of material to provide a prosthesis base having a patient-specific surface.

Suitable materials are, for example, acrylates or methacrylates, but also any other biocompatible material that may be applied to the prosthesis base body using the selected three-dimensional additive method may be used. It is preferred for the respective material to be monochrome and to have the same color shade as the prosthesis base body. This ensures that a high-quality result in terms of aesthetics is achieved, as the transition between the preformed standard prosthesis base body and the material applied additively is virtually invisible.

When the surface of the prosthesis base body facing away from prefabricated artificial teeth is realized as a flat surface, layer-building methods such as stereolithography may be particularly suitable.

Adhesion may be improved by pretreating the surface, such as roughening or primer application.

### BRIEF DESCRIPTION OF THE DRAWINGS

Further advantages, details and features will arise from the following description of an exemplary embodiment of the invention while making reference to the drawings, wherein

FIG. 1a-c is a schematic illustration of the prosthesis base body according to the invention,

FIG. 2 illustrates material application using the three-dimensional additive method,

FIG. 3 is a sectional view of the prosthesis base according to the invention following completion using the method of FIG. 2, and

FIG. 4 is a schematic representation of the computer-controlled material application of prosthetic material.

### DETAILED DESCRIPTION

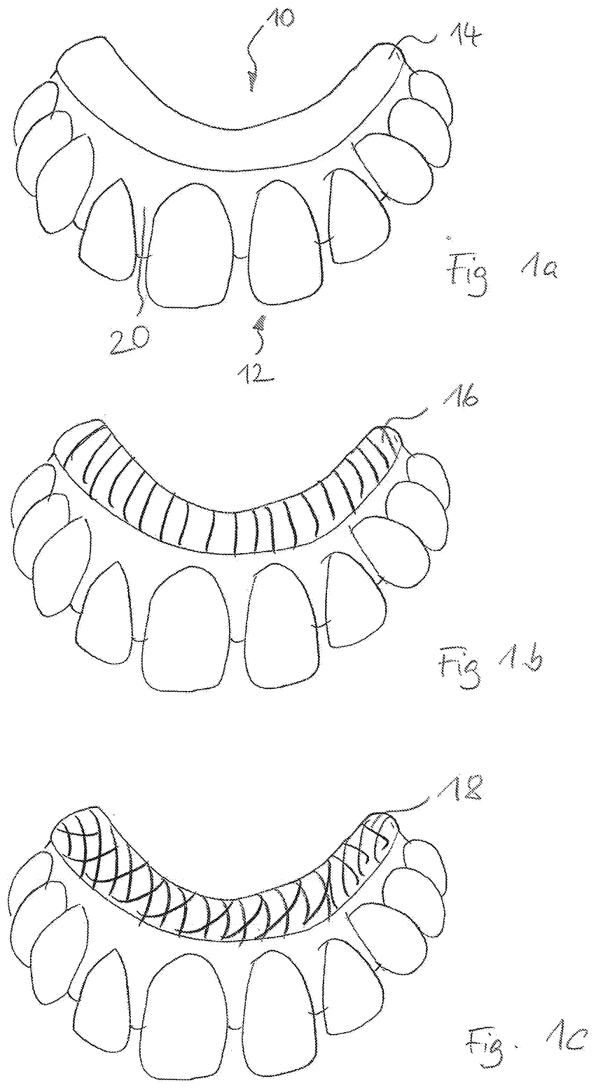

FIG. 1a shows a strongly schematic prosthesis base body 10. A dental arch 12, consisting of several artificial teeth, is glued into the base body 10. The material 20 of the prosthesis base body completely surrounds the dental arch 12 at its tooth necks. Opposite to the dental arch 12 the surface 14 is located, which, in this embodiment, is approximately flat.

In FIG. 1b, the surface 14 is provided comprising grooves, in FIG. 1c it is provided comprising a rather strongly structured surface, in this case a cross-shaped structure. In addition to the structures shown herein, the surface 14 may of course also be treated by any other surface treatment, such as roughening, increasing the effective surface area of surface 14 and thus improving adhesion of the surfaces to be applied according to the invention.

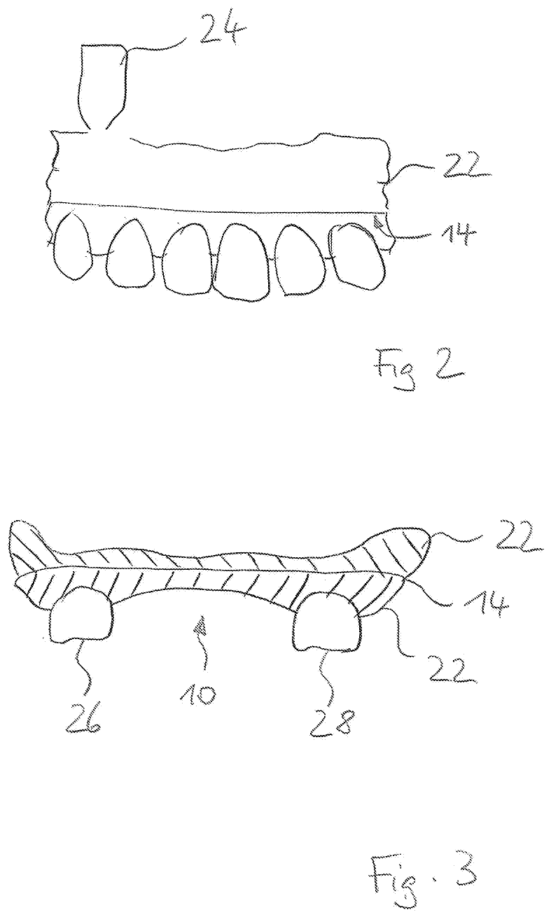

FIG. 2 shows how the material 22, e.g. acrylates or methacrylates, is applied to the surface 14 by a dispensing device 24 using the method according to the invention. In FIG. 2, thickness of material application is illustrated in a clearly overstated manner for better clarity.

The dispensing device 24 is controlled by the CAM device 30, schematically shown in FIG. 4, and recurrently travels in a grid-like manner across the surface 14, which is indicated by the double arrow 36, dispensing material depending on the data 32 provided by the CAD device 34. Material output which is activated or deactivated depending on the data 32 and the actual grid position of the output device 24 results in a 3D structure that corresponds to the negative shape of the patient's alveolar ridge, which has previously been captured by a 3D scanning process.

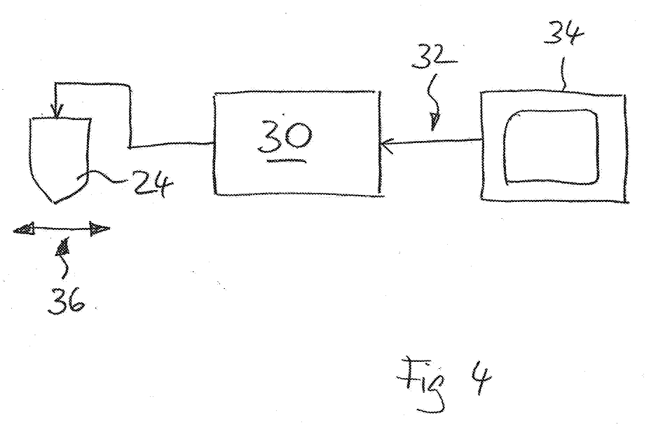

In FIG. 3, a sectional view is shown, with the section running across the prosthesis base starting from a molar 26 to a molar 28 opposite thereto. In this illustration it may readily be seen, how the individual artificial teeth 26, 28 are received in the material 20 of the prosthesis base body. The teeth 26, 28 are fixed thereto using a suitable adhesive. In FIG. 3, above the surface 14, the contour of the prosthesis base created by applying the layers of material 22 according to the invention, is shown very clearly.

By using a standard base body in combination with the 3D material application method, it is possible very easily to manufacture prostheses comprising a patient-specific prosthesis base with a high accuracy of fit and correspondingly high wearing comfort which meet high aesthetic requirements on the one hand, and on the other hand may still be fabricated with comparatively little expenditure in time and effort.

1. A method for manufacturing a dental restoration part according to patient-specific specifications comprising
providing a prosthesis base having one or more prefabricated artificial teeth, wherein the prosthesis base has a surface at a side facing away from the prefabricated artificial teeth, and
applying three-dimensional layer-by-layer material application onto the surface of the side facing away from the prefabricated artificial teeth using a three dimensional additive process,
wherein the material application onto the prosthesis base is produced according to the patient-specific specifications.

2. The method according to claim 1,
wherein the surface at a side facing away from the one or more prefabricated artificial teeth is a surface opposite to the one or more prefabricated artificial teeth, and
wherein the one or more prefabricated artificial teeth comprises a plurality of prefabricated artificial teeth.

3. The method according to claim 1,
wherein the surface of the prosthesis base facing away from the prefabricated artificial teeth is a flat surface.

4. The method according to claim 1,
wherein the additive process is a 3D printing process or stereolithography.

5. The method according to claim 1,
wherein the layer-by-layer material application uses a CAD/CAM device such that the three-dimensional shape produced by the material application corresponds to a negative image of a patient's alveolar ridge.

6. The method according to claim 1,
wherein, prior to layer-by-layer application of material to the surface of the prosthesis base facing away from the prefabricated artificial teeth, said surface is prepared by roughening, grooving or structuring, to create an enlarged effective surface.

7. The method according to claim 1, further comprising
pretreating the surface facing away from the prefabricated artificial teeth with a primer prior to layer-by-layer application of material onto the surface of the prosthesis base facing away from the prefabricated artificial teeth.

8. The method according to claim 1,
wherein the prosthesis base comprises a material which can be thermally and plastically deformed by the action of heat.

9. The method according to claim 8,
wherein the shape of the plastically deformed prosthesis base is optically detected to provide prosthesis base data and
wherein said data is transmitted to a CAD/CAM device.

10. The method according to claim 1,
wherein reference points of the prosthesis base comprising X and Y coordinates of one or more prefabricated artificial teeth are detected and the artificial teeth data is transmitted to a CAD/CAM device.

11. The method according to claim 1,
wherein the material to be applied layer-by-layer onto the prosthesis base comprise acrylates, methacrylates or a mixture thereof.

12. The method according to claim 1,
wherein the material to be applied layer-by-layer onto the prosthesis base is monochrome.

13. The method according to claim 1,
wherein the material to be applied layer-by-layer onto the prosthesis base in color corresponds to the material color of the prosthesis base.

14. A prefabricated product for a dental restoration part comprising
a prosthesis base, wherein the prosthesis base carries one or more prefabricated artificial teeth,
wherein the prosthesis base has a blank prefabricated surface at a side opposite to the prefabricated artificial teeth, which blank surface may be further modified to provide a patient-specific surface thereon.

15. The prefabricated product according to claim 14,
wherein the prosthesis base including the prefabricated surface is produced using an additive, a subtractive or a pressing technique.

16. A dental restoration part produced from a prefabricated product comprising
a prosthesis base, wherein the prosthesis base carries one or more prefabricated artificial teeth on one side and having a blank surface on a side opposite the one side with the artificial teeth,
wherein the blank surface is provided with additional layers of material to provide a prosthesis base having a patient-specific surface.

17. The dental restoration part according to claim 16,
wherein the one or more prefabricated artificial teeth comprise a plurality of prefabricated artificial teeth or a continuous tooth rim,
wherein the patient-specific surface comprises an additive finalized surface, and
wherein the side facing away from the one or more prefabricated artificial teeth is at a side opposite from the prefabricated artificial teeth.
